(19) United States
(12) Patent Application Publication
(10) Pub. No.: US 2015/0082921 A1
(43) Pub. Date: Mar. 26, 2015

(54) Robotic Sign Waving Device

(71) Applicant: Scott L. Posner, Chicago, IL (US)

(72) Inventor: Scott L. Posner, Chicago, IL (US)

(21) Appl. No.: 14/491,761

(22) Filed: Sep. 19, 2014

Related U.S. Application Data
(60) Provisional application No. 61/999,484, filed on Jul. 28, 2014.
(60) Provisional application No. 61/995,063, filed on Apr. 1, 2014.
(60) Provisional application No. 61/996,481, filed on May 7, 2014.
(60) Provisional application No. 61/965,694, filed on Feb. 3, 2014.
(60) Provisional application No. 61/965,456, filed on Jan. 30, 2014.
(60) Provisional application No. 61/965,161, filed on Jan. 25, 2014.
(60) Provisional application No. 61/965,024, filed on Jan. 22, 2014.
(60) Provisional application No. 61/960,911, filed on Sep. 30, 2013.
(60) Provisional application No. 61/960,673, filed on Sep. 24, 2013.
(60) Provisional application No. 61/960,547, filed on Sep. 20, 2013.

(51) Int. Cl. F16H 21/40; G09F 19/02

(52) U.S. Cl. CPC F16H 21/40; G09F 19/02
USPC 74/47

(57) ABSTRACT

A robotic sign waver has a chassis including a main plate which mounts a drive train. The drive train includes a motor and a gearbox coupled to the motor. The gearbox has an output shaft that drives a crank arm with a linkage rod attached thereto. The linkage rod drives a rocker plate that is mounted on the main plate for repetitive motion. An elongated waving arm is mounted on the rocker plate for repetitive motion with the rocker plate. The rocker plate is robust to withstand the stress and wear of repetitive motion while the waving arm is relatively light to minimize its load on the drive train. A counterweight is attached to the rocker plate on the opposite side of the main plate from the rocker plate by means of connectors extending through slots in the main plate. A reversible connector plate allows attachment of the chassis to either vertical or angled sign boards.

### CROSS REFERENCE TO RELATED APPLICATIONS

The present application claims priority to and benefit of U.S. Provisional Patent Application Nos. 61/999,484, filed Jul. 28, 2014, 61/995,063, filed Apr. 1, 2014, 61/996,481, filed Feb. 24, 2014, 61/965,694, filed Feb. 3, 2014, 61/965,456, filed Jan. 30, 2014, 61/965,161, filed Jan. 25, 2014, 61/965,024, filed Jan. 22, 2014, 61/960,911, filed Sep. 30, 2013, 61/960,673, filed Sep. 24, 2013, and 61/960,547, filed Sep. 20, 2013, each of which is hereby incorporated by reference in its entirety.

### FIELD OF THE DISCLOSURE

The present disclosure relates generally to signage conveying information such as advertisements, promotions or other textual and/or graphical messages. More particularly, but not exclusively, the present subject matter relates to a sign display assembly having a visually enticing component such that the attention of passersby will be directed to the sign board.

### BACKGROUND

It is a typical practice across all industries to use signage to market goods and/or services. Advertising signs can take a variety of forms but are most commonly recognized when presented as yard signs, sandwich board, or billboards. Because signage is very practical (low-cost, ease of use, potential of exposure, etc.), many persons and businesses employ this method of marketing. As a result, the world we live in is a very crowded advertising space in which consumers overlook many marketing attempts using traditional, plain signage. Accordingly, there exists a need for improved signage that compels the attention of passersby.

The present invention seeks to improve marketing efforts by stimulating visual contact with signage. Specifically, the signage of the present disclosure includes a movable arm mounted to a sign board, wherein the movement of the arm includes rotating, oscillating and rocking. The motion of the movable arm of the signage assembly compels the attention of passersby resulting in visual contact with the advertisement on the sign board.

### SUMMARY

This disclosure is in the area of advertising for signage. It is a way to drive more attention to signage in a crowded advertising space. This device rotates, oscillates or rocks back and forth an arm to which is affixed to some eye catching geometry, e.g., a red arrow, a face, a hand, etc. The arm and its driving mechanism mount behind a sign board such as a plastic yard sign, a sandwich board or billboard. The motion of the robotic waving arm will help to attract visual contact with the sign to which it is attached. The robotic hand waver is designed to be attached to almost any existing sign such as a plastic yard sign that gets pushed into the ground or hung on posts, sandwich boards, “A” frame signs or billboards, but it can also be built and integrated into signs and sold as one complete unit.

Design goals of the disclosure include, but are not limited to, low cost and easy installation.

The disclosure seeks to improve marketing efforts by stimulating visual contact with sandwich boards, “A” frame signs, yard signs, billboards and similar signage which is approximately 18″×24″ or 24″×36″. However, larger and smaller scale units can easily be developed using the same system. The mechanism can impart repetitive motion, which includes rotating, spinning, oscillating and/or reciprocating, such as a rocking motion (back and forth motion), depending how the linkage is attached to the gearbox output shaft to convert rotary motion to rocking motion. The speed can vary from approximately 7-60 spins or cycles/minute or at the desired speed that creates the best visibility of the waving arm or hand. The speed can be changed by the type of motor being utilized and the choice of power source, e.g., batteries, AC and/or solar panels, or any combination of power sources. For rotary spin the gear motor can be attached directly to the waving arm. For rocking motion the gear motor is attached to a linkage converting rotary motion to rocking motion, e.g., back and forth motion.

Drive power can come from batteries, AC or solar energy or any combination thereof. If solar power is used for an outdoor sign, a light sensor can disable power to the unit so at darkness the motor will turn off. Automatic operation with sensors can be utilized.

The components that make up the mechanism include a motor, motor wheel, linkages attaching the motor wheel to a moving arm and batteries, AC or solar panel or any combination thereof. Or as further described, the robotic sign waver comprises a small DC gear motor and a lightweight waving arm mounted on a common base and by a mechanical linkage. The gearhead output shaft is oriented 90 degrees from the motor shaft making for a compact drive assembly. A slip clutch on the output shaft protects the mechanism. If an obstruction prevents the waving arm from moving in its normal motion, the slip clutch can control torque and provide soft starts or cushioned stops. The motor, gearhead and slip clutch can all be housed together so as to be non-exposed to help seal and protect these components from outdoor weather conditions. Alternately, the gearhead shaft can be oriented parallel to the motor and can connect to the slip clutch and linkages and can all be housed together non-exposed. However this system will not be as compact.

A crank arm attached to the output of the gear motor rotates continuously in one direction. This crank arm is connected to the waving arm by a connecting link and a connecting plate, converting rotary motion to rocking motion.

The components can be attached to a common base and fastened to different types of signage, e.g., sandwich boards, yard signs, billboards, walls, buildings, and the like.

If solar power panels are used the panels can be attached to the end of a steel plate or mounted away from the mechanism via a wire that can carry the electrical charge of the solar panel. If the solar panel is attached away from the steel plate mechanism a mounting bracket will be used for support. The system can also operate on batteries held in a case attached to the back of the sign or steel plate which holds the high value components, e.g., the gear motor, linkages, hand and arm waver.

At the end of the moving arm an attachment mechanism allows different sized objects to be secured for altering advertising themes.

A desirable feature is some kind of self-destruct capability that renders the device's high value components (solar panel and gear motor) useless in the event of tampering.

Additionally in an advanced set-up scheme a steel thin plate is used to mount all of the hardware to the gear, motor & linkages. The metal plate runs horizontally on the back of the sign to add additional support to the signage especially when using corrugated plastic or other inexpensive flexible materials. The additional support of the steel bar also helps in inclement weather such as high winds when typically corrugated plastic signs tend to bend and crack.

The steel plate when attached using the center hole to mount the sign on a pole or other support acts as an anti-theft device. The hole in the center of the steel plate is designed to nail the sign through it and into a wooden pole or wood support. Once nailed with the plate in place it will be more difficult to tear down or steal the high value components which are attached to the steel plate using expansion screws on the back of the sign. This steel plate holding the high value components can be mounted directly to the back of an existing sign via bolts or screws through the holes in the metal plate holding the motor, motor wheel and linkage arms. Additionally a steel plate can hold the solar panel as well and be nailed to a wood post or support for additional anti-theft properties. The solar panel can be placed at an ideal location anywhere within the proximity of the motor and supply power to the motor via an electrical wire.

The steel plate which has the high value components secured to it by fasteners of any kind can vary in sizes to accommodate different size signs from 18″×24″ yard signs, sandwich boards 24″×36″, “A” frame signs and even large billboards by increasing the size and power of the motor and connecting linkages. The metal plate can be secured to an existing sign by fasteners which are secured through holes on the metal plate. Multiple holes can be drilled on any length of the steel or plastic band or bracket plate for properly securing it to the signage. Typically the steel band or plastic band would be approximately made of 22 gauge metal or similar thickness of plastic, with a length of approximately 15″ and a width of 2″-4″ inches. The metal or plastic bracket plate would be of the same thickness with an approximate length of 5″-7″ inches and a height of3″-5″ inches. This is a compact mechanically driven motor system to move the waving arm with adequate torque to be used outside in windy rainy inclement conditions.

The steel plate which has the high value components (“gear motor, mechanical linkage and waving arm can be attached to sandwich boards or “A” frame signage the back of yard signs or any size or type of signage including billboards. The mechanism can be self-contained so it is easily handled as a single unit and can be mounted to poles, temporary or permanent including buildings. The steel plate on the mechanism can support the attachment of a sign on the front while also attaching itself to a post, pole, building or any type of architecture.

In another design the steel plate or frame that holds all the high value components can be secured to sandwich style signs. Since a sandwich board is angled at both sides additional hardware can be provided. The metal band or frame can be secured with fasteners of all kinds, e.g., screws, nuts, bolts at the top of one of the back sides of the vertically upright sandwich board. The bracket which will be at an angle to position that the rotating or rocking arm so it is perpendicular with the ground or base of the sandwich board and can be easily viewed by an observer. Additionally the robotic hand waver can be attached directly to the face of the sandwich board with screws through holes in the steel or plastic band or bracket plate which contains all of the high value components. The steel band or bracket plate has flexibility and if need be can be slightly bent out on opposite sides to create a more perpendicular alignment so that the robotic waving hand is not pointing at an angle but is perpendicular with the ground for proper viewing. The steel band or bracket plate which holds of the components can be made of any material metal, plastic or other. The waving reciprocating or rocking arm can be made of lightweight plastic or any other material, preferably waterproof. The plastic band can be molded with any angle to support the waving arm perpendicular with the ground. The bracket plate is approximately 3″-5″ in Height, 4″-7″ inches in length, 3″-4″ thick and approximately made of 22 gauge thick steel and can be attached directly to any advertising sign horizontally, vertically or sloped. The steel band or bracket plate can be made of any material metal, plastic or mold injected plastic material of any kind. The bracket can have sides to create additional strength and can be constructed in the shape of a box, solid or fastened together with sides and a partially exposed top to allow the waving arm or hand to reciprocate or rock back and forth. The waving reciprocating or rocking arm can be made of lightweight plastic or any other material preferably waterproof.

### BRIEF DESCRIPTION OF THE DRAWINGS

FIG. 1 is a left side elevation view of one embodiment of the sign waving device of the present disclosure with the cover and connector plate in exploded positions.

FIG. 2 is a left side elevation of the sign waving device and including the connector plate shown in solid lines in position for attachment to an angled sign board and also shown in phantom lines in a reversible position for attachment to a vertical sign board.

FIG. 3 is a top plan view of the sign waver, with the cover, motor and gearbox and the counterweight in exploded positions and the connector plate removed.

FIG. 4 is a top plan view of the sign waver on an enlarged scale and with the connector plate removed.

FIG. 5 is a front elevation view of the sign waver with some hidden parts shown in phantom lines, and with a left side portion of the main plate cut away to show the cover's left side wall and optional insulation in the cover, and with a portion of the connector plate and waving arm cut away to show the top left corner of the rocker plate.

FIG. 6 is a front elevation view of an alternate embodiment of the sign waver with the front plate of the bracket removed to expose parts behind it.

FIG. 7 is a left side elevation view of the sign waver with the front plate of the bracket assembly shown in an angled position to accommodate attachment to an angled sign board.

FIG. 8 is a left side elevation view similar to FIG. 7 but with the front plate of the bracket assembly shown in an alternate, vertical position.

FIG. 9 is a left side elevation view of an adaptor that can be used to mount a vertical bracket front plate to an angled sign board.

FIG. 10 is a left side elevation view of the sign waver mounted on a sandwich board.

FIG. 11 is a front elevation view of the signage assembly of FIG. 10.

FIG. 12 is a left side elevation view of the signage assembly with the sign waver portion separated slightly from a sandwich board.

FIG. 13 is front elevation view of a portion of the drive train, with the waving arm in an exploded position.

FIG. 14 is a front elevation view similar to FIG. 13 but showing an alternate form of a rocker plate.

FIG. 15 is a front elevation view similar to FIG. 6 but showing a further alternate embodiment of the sign waver with a counterweight added to the rocker plate.

FIG. 16 is a left side elevation view similar to FIG. 8 but showing a further alternate embodiment of a sign waver with a slide out card on which the motor is mounted.

FIG. 17 is a left side elevation view similar to FIG. 7 but showing a further alternate embodiment of a sign waver with a brace for the front plate of the bracket.

FIG. 18 is a schematic top plan view of the brace B of FIG. 17 on a smaller scale.

### DETAILED DESCRIPTION OF THE EMBODIMENTS

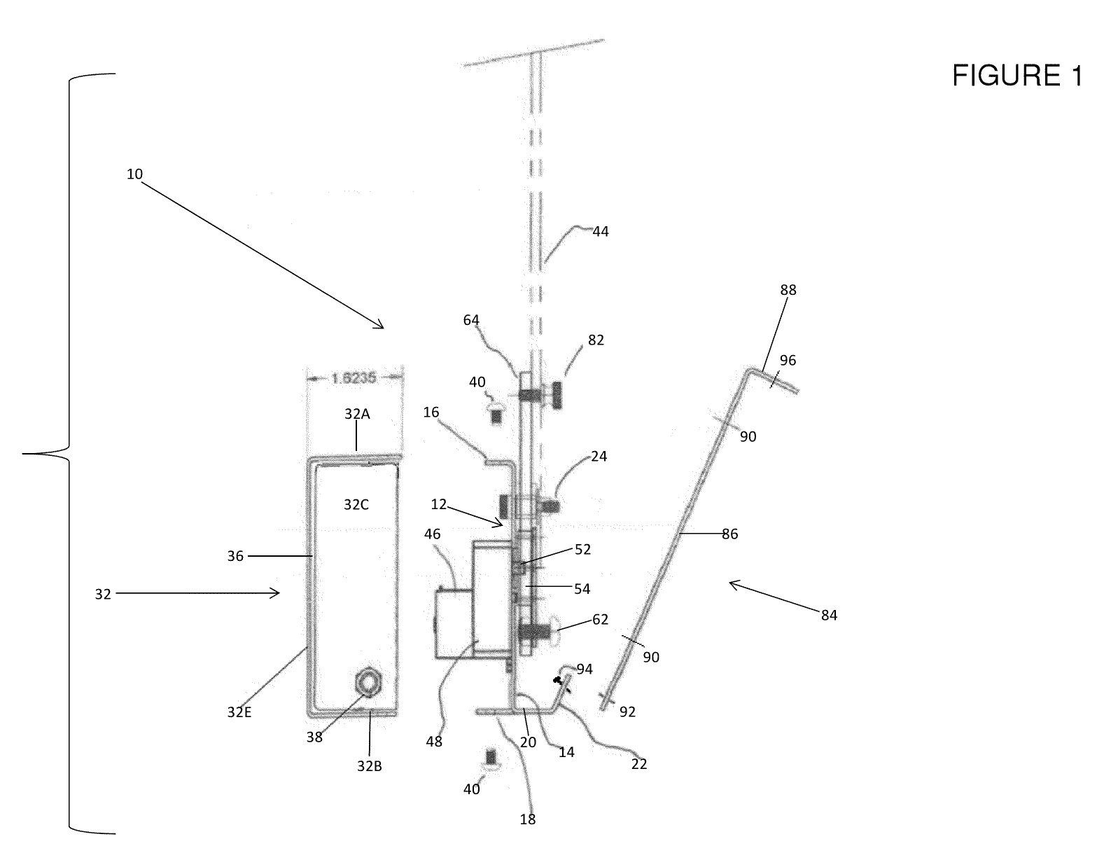

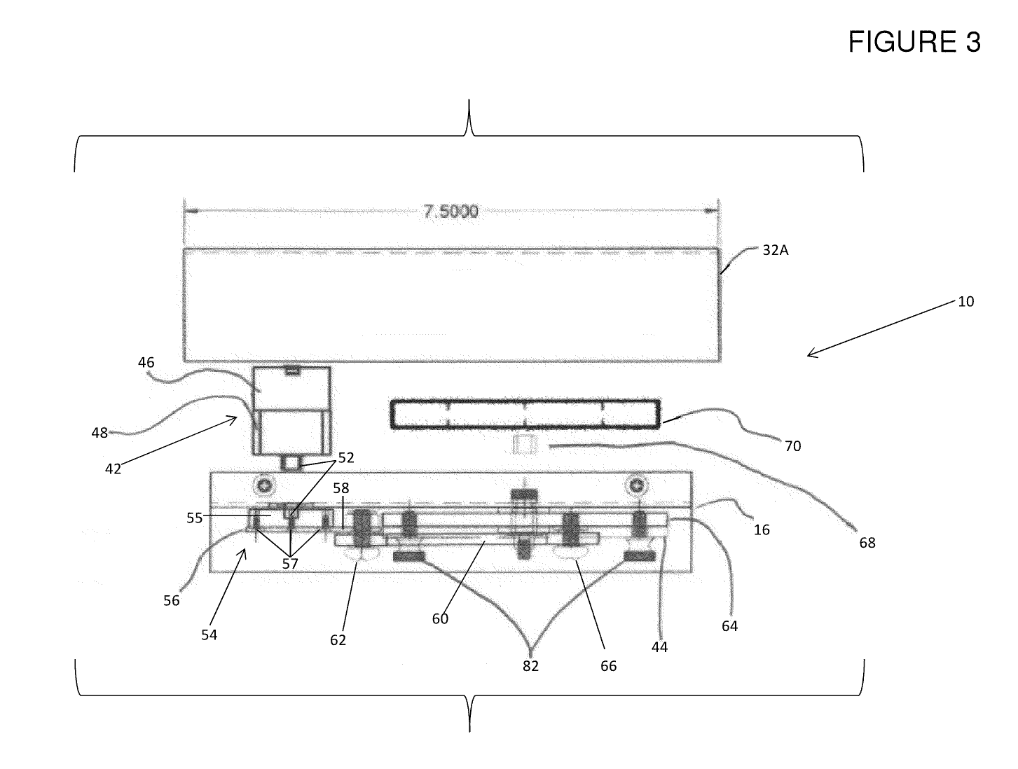

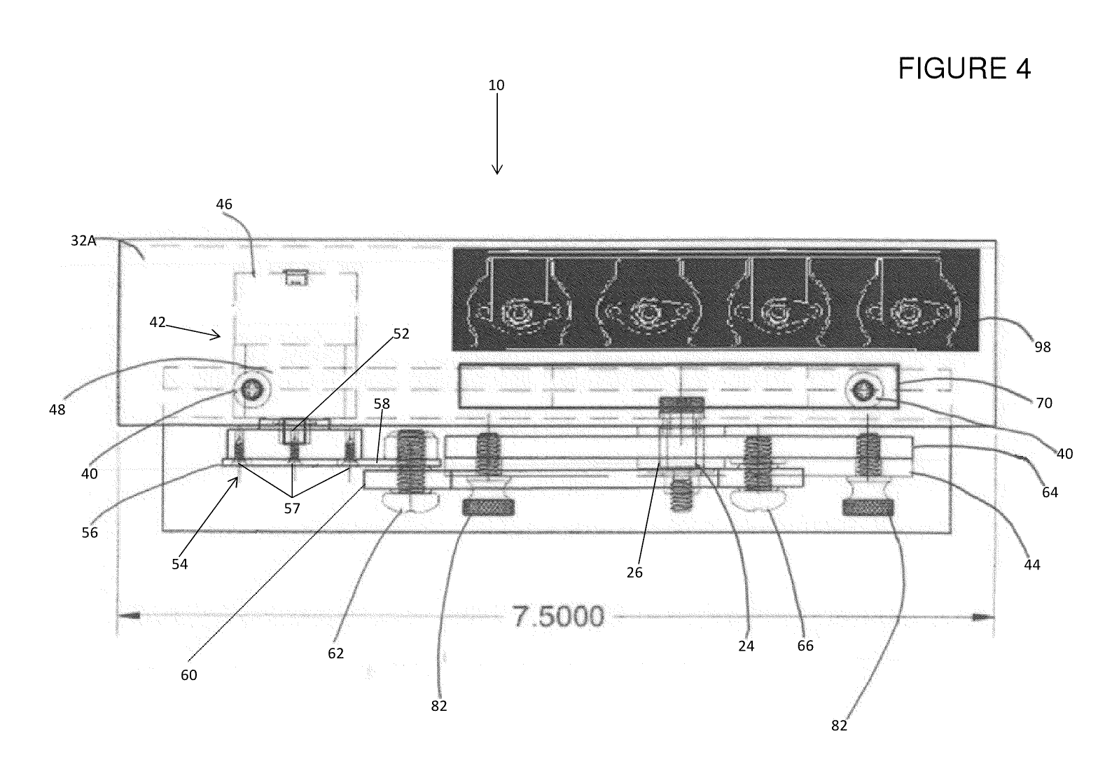

The robotic sign waving device, or sign waver, of the present disclosure is shown generally at 10 in FIGS. 1-5. Its basic structural element is a chassis, indicated generally at 12, which mounts the other components of the sign waver. The chassis 12 includes a vertical main plate or blade 14. A generally horizontal upper flange 16 extends rearwardly from the top edge of the main plate 14 while a horizontal lower flange 18 extends rearwardly from the bottom edge of the main plate 14. The upper and lower flanges add rigidity to the main plate. They also serve as attachment points for a cover, as will be explained below. While the flanges are shown as extending the full width of the main plate, it could be otherwise. For example, one or more narrower tabs could be formed on either or both of the top and bottom edges of the main plate to form cover mounting tabs that accept the cover fasteners. It will be noted in FIGS. 1 and 4 that the lower flange 18 extends rearwardly somewhat farther than does the upper flange.

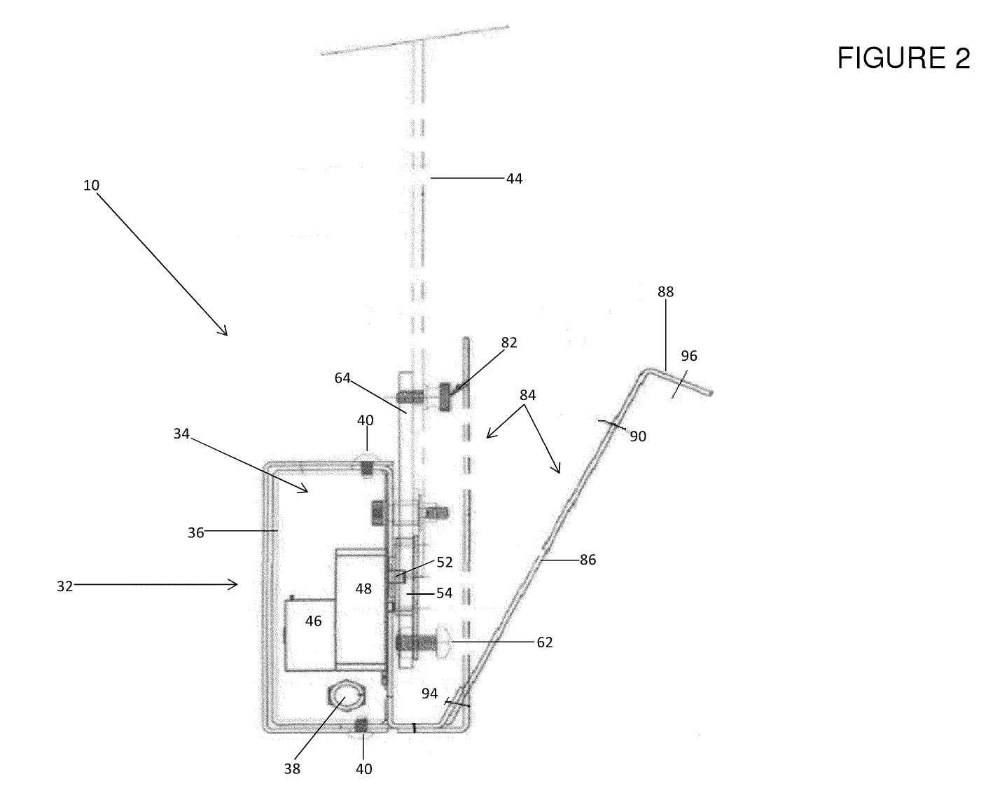

Opposite the lower flange 18 of the chassis 12 there is connected to the main plate 14 a forwardly-extending, horizontal foot 20. The foot preferably extends the full width of the main plate. The foot has apertures (not shown) for receiving fasteners for the connector plate, as will be described below. The edge of the foot 20 opposite the main plate 14 carries a toe plate 22. The toe plate is angled upwardly from the horizontal foot, as seen in FIGS. 1 and 2. The toe plate 22 also has apertures (not shown) for receiving fasteners for the connector plate. The foot 20 and toe plate 22 provide alternate locations for mounting the connector plate, allowing the connector plate to be mounted either vertically or in an angled position.

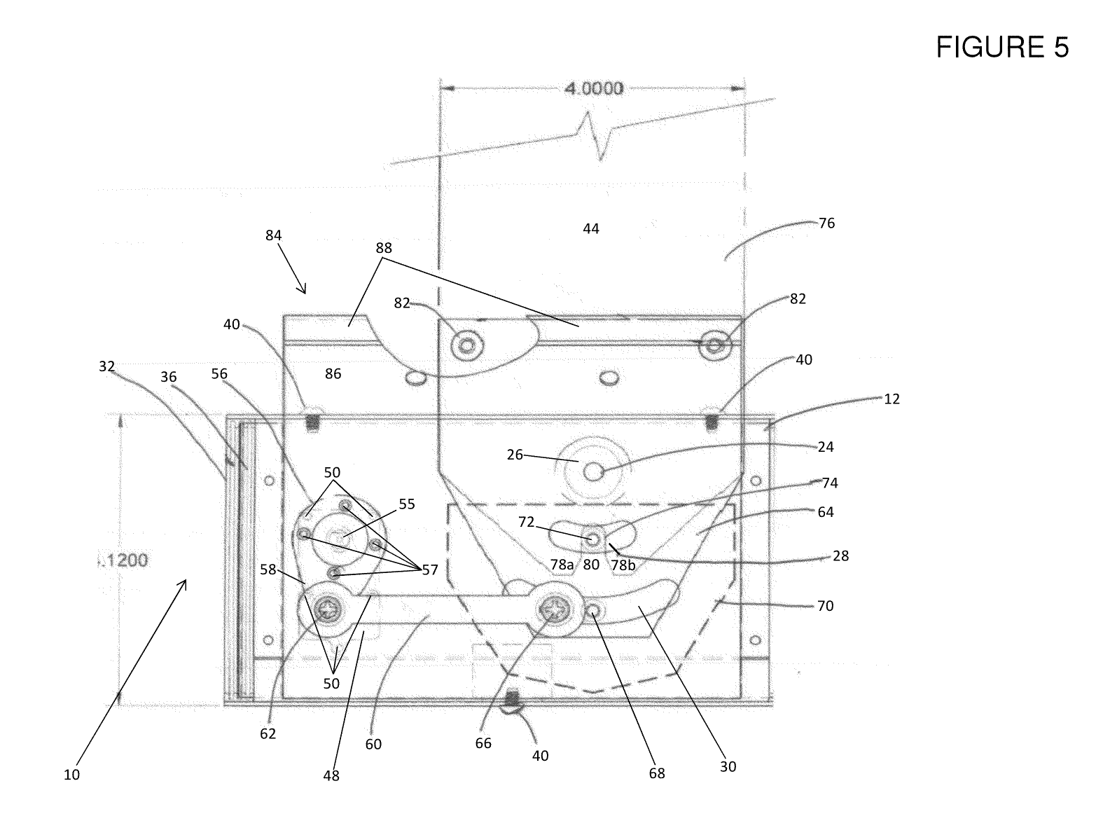

The main plate also has an aperture through which a pivot shaft 24 extends. The pivot shaft is fixed to the main plate 14 of the chassis and carries a bearing 26 as best seen in FIG. 5. The bearing permits rotational motion about the pivot shaft, as will be described below. FIG. 5 also illustrates a pair of arcuate slots, an upper slot 28 and a lower slot 30. The upper and lower slots 28, 30 extend all the way through the thickness of the main plate, thereby providing access between the front and rear sides of the chassis 12 through the main plate 14. The upper and lower slots each define an arc. The arcs have a common center which is concentric with the axis of the pivot shaft 24.

As mentioned above, the upper and lower flanges 16, 18 removably mount a cover, which is shown generally at 32. The cover is preferably a five-sided enclosure having a top wall 32A, a bottom wall 32B, left and right side walls 32C, 32D and a rear wall 32E. These walls collectively define a hollow enclosure 34 (FIG. 2). Optionally the interior surfaces of the walls may be lined with insulation 36 to dampen any noise from the motor and gear train. The left side wall 32C carries a power input connector or plug 38.

The height of the cover walls matches the distance between the upper and lower flanges 16 and 18. As such the inner faces of the top and bottom walls 32A, 32B lie just above and below the upper and lower flanges, respectively. This affords a snug but removable fit of the cover 32 on the flanges 16, 18. Also, the width between the side walls 32C, 32D is just slightly greater than the width of the main plate 14. Thus, the main plate fits closely within the open side of the cover to provide a weather-tight engagement. The top and bottom walls 32A, 32B have apertures (not shown) which align with the apertures in the upper and lower flanges 16, 18 to receive threaded fasteners 40 that removably secure the cover 32 to the chassis 12.

The moving parts of the sign waver include a drive train 42 and a waving arm 44. Details of the drive train will now be described. It includes an electric motor 46 which is integrated with a gearbox 48. The gearbox is fixedly mounted on the rear face of the main plate 14 of the chassis by plurality of bolts 50 (FIG. 5). The gearbox includes an output shaft 52 which extends forwardly through an opening in the main plate 14 to the front side of the main plate. A two-part crank arm is shown generally at 54. It has a cylindrical hub 55 to which a crank plate 56 is attached. The crank plate 56 has a circular body portion that is attached to the hub 55 by screws 57. The crank plate also has a lobe 58 extending radially from the body portion of the plate. The hub 55 is fixedly mounted on the gearbox output shaft 52 for rotation therewith on the front side of the main plate 14. The outer end of the lobe 58 is connected to a linkage rod 60 by a crank arm pin 62. The pin 62 allows relative rotation between the lobe 58 and the linkage rod 60. The other end of the linkage rod is connected to a rocker plate 64 by a rocker plate pin 66. The pin 66 allows relative rotation between the rocker plate 64 and the linkage rod 60. The removable crank plate 56 allows changing the motion imparted to the linkage rod by altering the length and/or location of the lobe.

The rocker plate 64 has an aperture that receives the bearing 26 on the pivot shaft 24. This mounts the rocker plate for pivotal motion on the pivot shaft on the front side of the main plate 14. The lower half of the rocker plate 64 has connectors in the form of a stubshaft 68 and a post 72 fixed thereto. See FIG. 5. Both the stubshaft 68 and the post 72 extend rearwardly through the lower arcuate slot 30 and the upper arcuate slot 28, respectively. On the rear side of the main plate the stubshaft and post are fixed to a counterweight 70. The arcuate slots 28 and 30 permit arcuate motion of the stubshaft and post with the rocker plate 64. Accordingly, the counterweight 70 will move with the rocker plate 64. Mounted on the post 72 is a bushing 74. The bushing is used to locate and secure the lower end of the waving arm 44.

Turning now to details of the waving arm 44, it can take any shape or form desired by an advertiser. A typical but by no means limiting example is to have an elongated member carrying at its upper end a representation of a hand. Alternately, the elongated member might carry a representation of the product being advertised. The possibilities are endless. The difficulty, however, lies in the fact that the waving arm and drive train must be able to withstand the rigors of constant oscillatory motion, as well as wind loads that can be significant. By way of example, and not by limitation, the elongated member may be on the order of 22-24 inches long. With a waving arm of this size, a significant moment is produced which further stresses the drive train. The weight of the waving arm also becomes an issue. Arms capable of withstanding wind loads and constant oscillatory motion can be so heavy as to require a powerful drive train that is costly and will quickly drain available battery power. Furthermore, the waving arm must be readily changeable to suit a particular advertiser's needs.

The present disclosure addresses these issues by providing a drive train made of materials capable of withstanding long-term oscillatory motion and moment generated on the waving arm, while providing a lightweight waving arm that can readily be removably attached to the drive train. The waving arm itself is not subjected to the stresses of the drive train. It is mounted on the rocker plate 64 and is merely along for the ride. The rocker plate, on the other hand, is a comparatively robust structure that can withstand the wear resulting from the moment transferred from the waving arm and the repetitive stresses transferred from the linkage rod 60. The waving arm 44 can be made of corrugated plastic stock sheets such as Coroplast® available from Coroplast LLC of Livingston, N.J., although other materials could be used.

The waving arm 44 has an elongated member of a suitable length. A portion of the elongated member is shown schematically at 76 The lower end of the elongated member has sloping end walls that define wings 78A, 78B. The wings are spaced apart by a locating slot 80. The waving arm is removably attached to the front face of the rocker plate 64 as follows. An installer slides the lower end of the elongated member 76 down the front face of the rocker plate 64 until the rocker plate's bushing 74 is engaged in the locating slot 80. The locating slot 80 is sized to receive the bushing in a snug, secure but releasable fit. Then two thumbscrews 82 are screwed through the elongated member into apertures near the top of the rocker plate 64. With the thumbscrews in place, the waving arm is secured to the rocker plate for movement therewith.

The drive train causes oscillatory movement of the waving arm 44 as the crank arm 54 translates the rotational motion of the motor and gearbox output shaft 52 to reciprocating linear motion of the linkage rod 60. The linkage rod drives the rocker plate 64 back and forth, with the rocker plate pivoting on bearing 26 on the pivot shaft 24. When the motor is turned on the waving arm 44 rocks back and forth in a waving motion or gesture. The counterweight 70 balances the effective moments about the pivot shaft 24 of the oscillating rocker plate 64 and waving arm 44, thereby reducing the power requirements of the drive train and the wear on the moving parts.

The sign waver portion of the device described thus far is preferably mounted on a sign board of some type. This may be a vertical board or an angled sign board known as a sandwich board. The present disclosure provides a connector plate 84 that can accommodate either type of sign board. The connector plate 84 has a body portion 86 and a flange 88. The flange 88 is perpendicular to the body portion 86. The body portion has apertures, shown schematically at 90 in FIGS. 1 and 2, for receiving fasteners that will attach the body portion to either type of sign board. The body portion has additional apertures indicated at 92 that will align with those of the toe plate 22. This will permit fasteners 94 to attach the body portion 86 of the connector plate 84 to the toe plate 22. This will mount the connector plate 84 at about a 65° angle to the horizontal. In this attitude the angled connector plate 84 has the same slope/angle as a standard sandwich board and will lie against the side of the sandwich board and attach to the angled handle at the top of the sandwich board (not shown). At the same time the connector plate 84 will maintain the chassis 12, and therefore the waving arm 44, in a generally vertical plane.

In the event it is desired to mount the sign waver on a vertical sign board, the connector plate's flange 88 also has apertures, indicated at 96, that will align with those of the chassis' foot 20. That is, the connector plate 84 can be reversed from the position shown in FIG. 1 and the flange 88 is tucked under the foot 20 and attached thereto. This is shown in phantom lines in FIG. 2. The flange 88 has a length such that when the connector plate 84 is so mounted on the foot 20, the body portion 86 of the connector plate will clear the upstanding toe plate 22. This affords a generally vertical attitude for the body portion 88, allowing it to be attached to a vertical sign with the chassis 12 in a vertical plane. Thus, a single connector plate 84 is reversible to accommodate any style of sign board.

In this design all of the high value components e.g. the motor/gearbox unit 46, 48, the crank arm 54, the linkage rod 60, the rocker plate 64 and the counterweight 70 are all fastened to a single chassis 12. However, the motor 46 with the coupled gearbox 48 and the counterweight 70 are attached to one side of the chassis' main plate (the rear side) and the other components are attached to the other side of the main plate (the front side). The components are coupled through openings in the chassis through which the gearbox output shaft 52, the stubshaft 68 and the post 72 extend.

This design which has a cover 32 over the motor 46, gearbox 48 and counterweight 70 has several advantageous features. The motor and gearbox can be readily accessed if they need to be serviced or replaced. The counterweight can swing unobstructed as shown by the drawings. Also the cover over the motor allows room for optional insulation 36 to help reduce noise from the motor if need be. Additionally, inside the cover there is room for a battery holder 98 (FIG. 4) to mount batteries for powering the device. Alternately, a grid power input connector 38 is located on one side 32C of the cover for an additional power source. The grid power input connector can be used as an alternative to the batteries. It can also be used to recharge the batteries if rechargeable batteries are used inside the cover box. The input connector can also be used to supply power from solar panels or from an AC/DC converter. The cover also can be made watertight to keep the motor and batteries dry. The cover 32 is fastened with three screws 40 against the flanges 16, 18 on the side of the single blade/chassis 14 and houses the motor 46, its coupled gearbox 48, the counterweight 70, batteries 98 and a power input connector 38. All dimensions shown in the drawings are in inches.

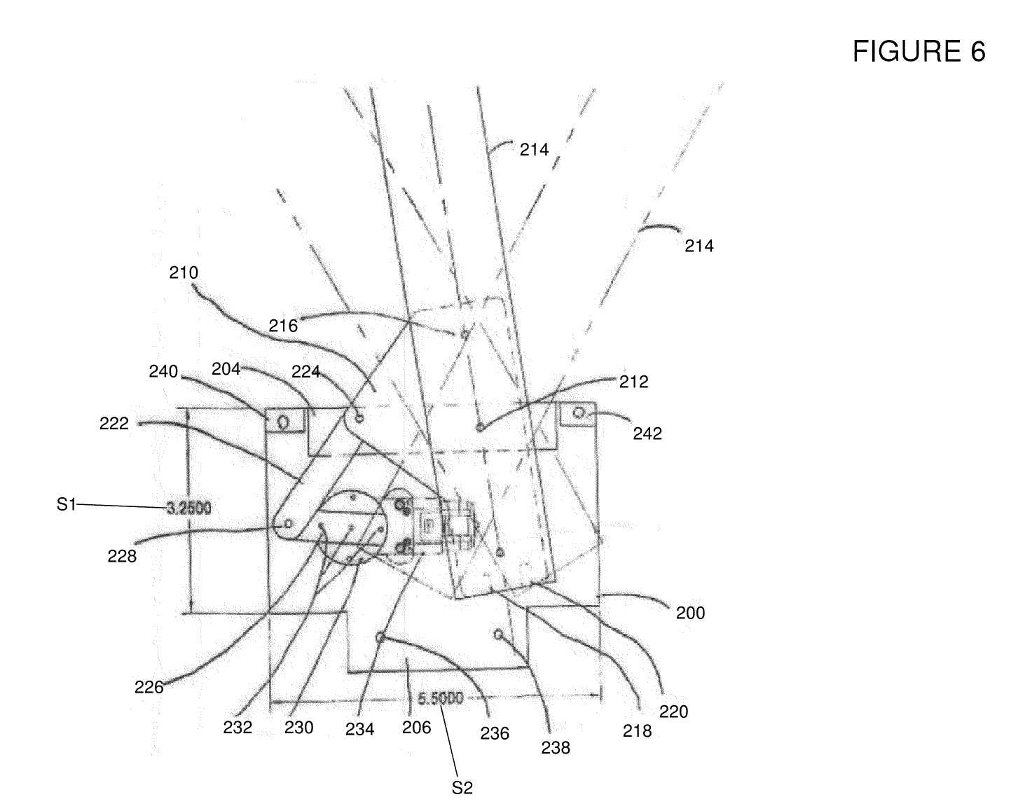

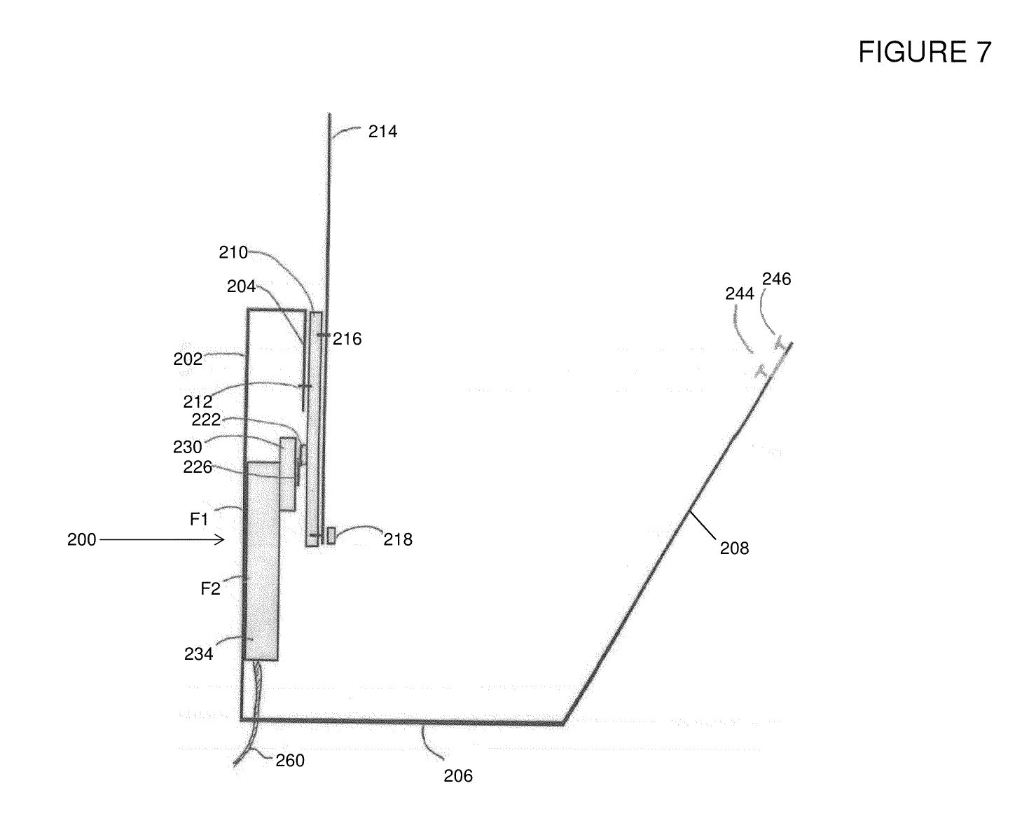

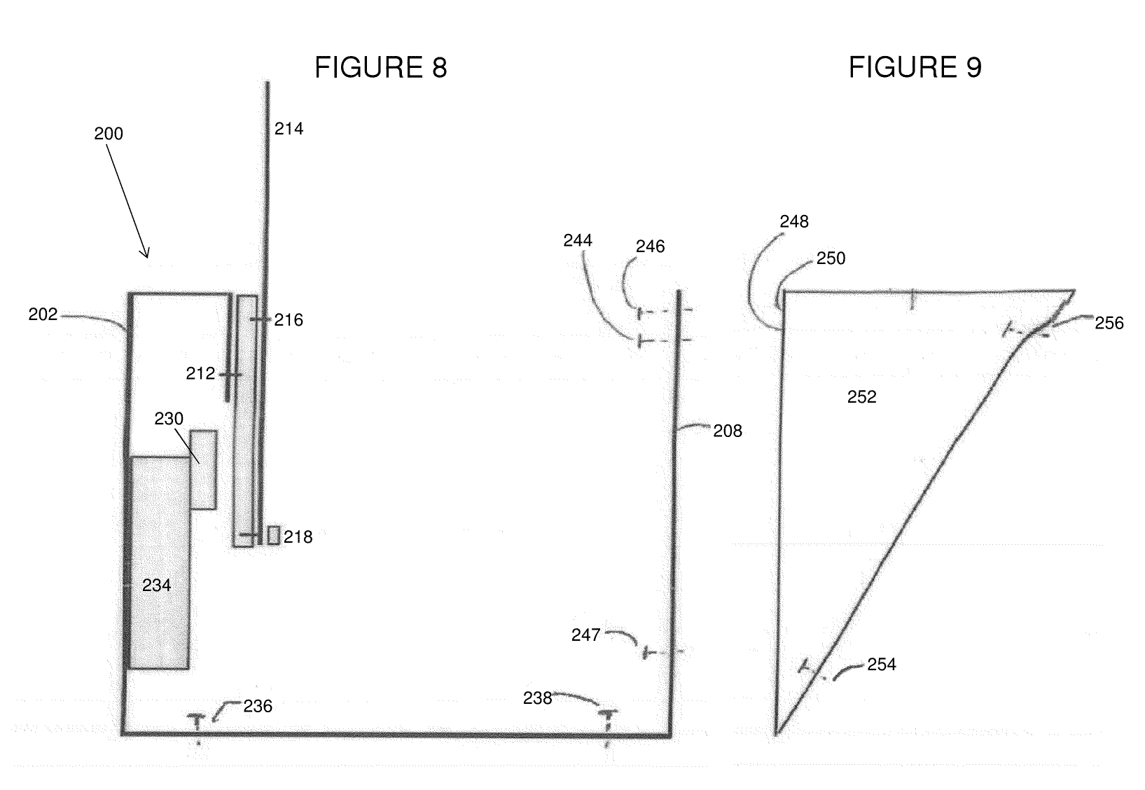

Turning now to FIGS. 6 and 7, an alternate embodiment of the sign waver portion of the signage assembly of the present disclosure is shown. The signage assembly has a mounting bracket 200 which is bent such that it provides a generally enclosed housing for other sign waver components. The mounting bracket 200 includes a generally vertical back plate 202 that is connected to a front flap 204 on one end, and is also connected to a horizontal base flap 206 and terminates in a mounting flap 208 on the other end (FIG. 7). The mounting flap 208 can be bent to either an angled position as shown in FIG. 7 or to a vertical position as shown in FIG. 8.

FIGS. 6 and 7 illustrate that the components of the sign waver portion of the signage assembly, e.g. the motor, the gear head shaft, the linkage, the crank arm and the rocker plate 210, are attached to either the back plate 202 or the front flap 204. FIG. 6 also illustrates a moving or waving arm 214 in three positions, two of which are shown in phantom lines. Waving arm 214 is the portion of the assembly that consumers will see and as such it can take any size or shape desired by the advertiser. As just one example, the waving arm could take the appearance of a human arm with a hand attached at the top. The waving arm 214 can be made of any strong, lightweight material.

The waving arm 214 has apertures which receive a fastener 216 and pins 218, 220 to attach the waving arm 214 to the rocker plate 210. The rocker plate 210 is mounted for rotation about a pivot pin 212. The pivot pin 212 is fixed to the front flap 204. Waving arm 214 is not mounted on the pivot pin 212 but instead moves with the rocker plate 210 since waving arm 214 is fastened by pins 218 and 220 and fastener 216 to the rocker plate 210. This allows the waving arm 214 to be changed out quickly by releasing fastener 216 and pulling arm horizontally away from the rocker plate to release the arm from pins 218 and 220. The waving arm 214 can be made of Coroplast® stock sheets available from Coroplast LLC of Livingston, NJ. Other materials could be used. Channels could be formed in the arm to accept pins 218 and 220 from rocker plate 210. Alternatively, a post can be positioned at the base of rocker plate 210 so that the base of the waving arm 214 could have a cut out or notch near its base to accept the post. This alternative would permit elimination of pins 218 and 220. The waving arm 214 can be made of corrugated plastic which is made of channels to accept pins 218, 220 from rocker plate 210 or any other material with a notch at the base to accept the post.

Rocker plate 210 may be machined out of metal to have notches in its base to accept the pins 218, 220 so these pins can be pushed out so that waving arm 214 can be inserted into its channeled base. However, rocker plate 210 could also be made of plastic with pushed pins molded out. Rocker plate 210 could also be made of injection-molded plastic with a post centered at the base of rocker plate 210 to eliminate pins 218, 220.

FIG. 6 shows the mounting bracket 200 which holds all of the sign waver components to operate the waving arm 214. A linkage rod 222 is attached at one end to rocker plate 210 by a fastener 224 that extends through apertures in the linkage rod 222 and rocker plate 210. At its other end, the linkage rod 222 is attached to a crank arm 226 by a fastener 228 that extends through apertures in the linkage rod 222 and crank arm 226.

Crank arm 226 is attached to a gear head wheel 230 by fasteners 232 and is oriented 90 degrees from the motor shaft inside motor 234, which affords a compact drive assembly. The crank arm 226 attached to the linkage rod 222 converts rotary motion of the motor to rocking motion when connected to rocker plate 210 that is fixed at pivot pin 212 and is attached to the front flap 204 on mounting bracket 200 so that the rocker plate 210 can rock back and forth around the pivot point/axis 212. The front flap 204 is the upper bent portion of the mounting bracket 200.

In FIG. 6 the base flap 206 is shown as a vertical member for illustrative purposes only as the actual flap is bent 90 degrees from the position shown in FIG. 6 to a horizontal position as indicated in FIG. 7. The base flap 206 and serves as the base or bottom of the mounting bracket 200. The illustration of FIG. 7 shows that bracket 200 can be attached to a flat base surface horizontally such as the very top of a sandwich board or tabletop. The base flap 206 of the bracket 200 can be mounted to a horizontal surface via fasteners 236, 238. FIG. 6 also shows tabs 240, 242 that can optionally be used to affix bracket side walls (not shown) to the bracket 200 to further enclose the motor and gearbox.

The bracket 200 can be mounted to a sign either vertically or at an angle using fasteners 244, 246 as seen in FIGS. 7 and 8. To do this, fasteners 244, 246 would be inserted through the mounting flap 208 via holes in the outer edge of the flap. For attachment to a vertical sign, the mounting flap 208 could be bent to a vertical position as in FIG. 8. For attachment to an angled sign such as a sandwich board, the mounting flap would be bent to an angled position as in FIG. 7. Alternately, attachment to an angled sign could involve the use of an adaptor, such as shown at 252 in FIG. 9. The adaptor is a generally triangular piece having a vertical leg with openings 248, 250 for receiving the fasteners 244, 246 of the mounting flap 208. The hypotenuse of the adaptor 252 would then be secured to an angled sign using fasteners 254, 256.

FIG. 7 shows the bracket 200 in a side view with all same components as were depicted in FIG. 6. Specifically, FIG. 7 shows the bracket 200 housing the components such that they appear to be hidden from a front or rear view. As mentioned above, sides walls could be attached to bracket 200 via tabs 240, 242 to add support to the bracket 200 as well as to hide the internal components from the side. The tabs 240, 242 are a part of the front flap 204 of the bracket 200. In front of the front flap 204 is a small opening allowing the waving arm 214 enough space to rock back and forth.

FIG. 7 shows that the mounting bracket 200 is one continuous piece of bent metal or molded plastic that houses all of the sign waver components. In this view, the rocker plate 210 is shown removably attached to the front flap 204 of the mounting bracket 200 via a pivot pin 212. The waving arm 214 is affixed to the rocker plate 210 by fastener 216 and secured in place by pin 218. In addition to being an attachment point for the waving arm 214, the rocker plate 210 is attached to other components. Here, FIG. 7 shows the rocker plate 210 being attached to the crank arm 226 via the linkage rod 222. The crank arm 226 is also shown being attached to the gear head wheel 230, which in turn is connected to the motor 234. The gear head wheel 230 is oriented 90 degrees from the motor shaft inside the motor 234. Additionally, a slip clutch can be attached to the output gear and enclosed with motor and gear head. The motor is shown affixed to the mounting bracket 200 on the generally vertical back plate 202 using fasteners F1, F2 (FIG. 7). Power is supplied to the motor by power cord 260. Power could also be supplied using batteries, AC or solar power. Additionally, FIG. 7 shows that the bracket 200 can be secured to an angled sign using fasteners 244 and 246.

Gear head wheel 230 spins crank arm 226 with linkage rod 222 attached to rocker plate 210. Rocker plate 210 is mounted for rotation on fixed pivot/axis 212 which in turn is secured to front flap 204 of bracket 200. Rocker plate 210 can now swing or rock back and forth around pivot/axis 212. The base of waving arm 214 is attached to rocker plate 210 by pin 218. Waving arm 214 has a notch in its bottom center to accept pin 218. Waving arm 214 is secured to the top of rocker plate 210 by fastener 216. Waving arm 214 can be quickly attached and detached to rocket plate 210 by a screw or winged fastener of any kind, style or type including, but not limited to, a hook and loop fastener. In this configuration the waving arm, which may have a hand or other artwork or geometry attached or incorporated as one piece of the arm, can be switched out quickly for different promotional displays and advertising themes. The rocker plate 210 is attached to bracket 204 through pivot/axis 212 on flap 204 and rocks back and forth, the waving arm 214 can thus be quickly attached and detached to the rocker plate 210 without dismantling any of the other moving parts of the design. The bracket 200 is secured to the side or top of an “A” frame slanted sandwich board or other flat vertical wall or advertising sign. The arm thus waves back and forth and brings attention to an advertising sign or billboard.

FIG. 8 illustrates the same bracket 200 except mounting flap 208 is not angled but vertical and can be attached to the side of a vertical sign with fasteners 244, 248 through holes in the mounting flap 208. Bracket 200 can also be attached to the top of a sign or tabletop horizontally with fasteners 236, 238 through holes in the base flap 206. As mentioned above, FIG. 8 does not show sides on the bracket but additional sides could be fastened or molded as a plastic mold injection part. Bracket 200 can be made of injection-molded plastic with sides resembling a box like structure with a partially exposed top to allow the waving arm/hand to rotate.

FIG. 9 shows a generally triangular adaptor 252 arranged so that bracket 200 can be attached to an angled surface such as a sandwich board or “A” frame sign. The adaptor would fasten to the angled sign first and then bracket 200 could attach with fasteners 244, 246 extending through holes 248 and 250.

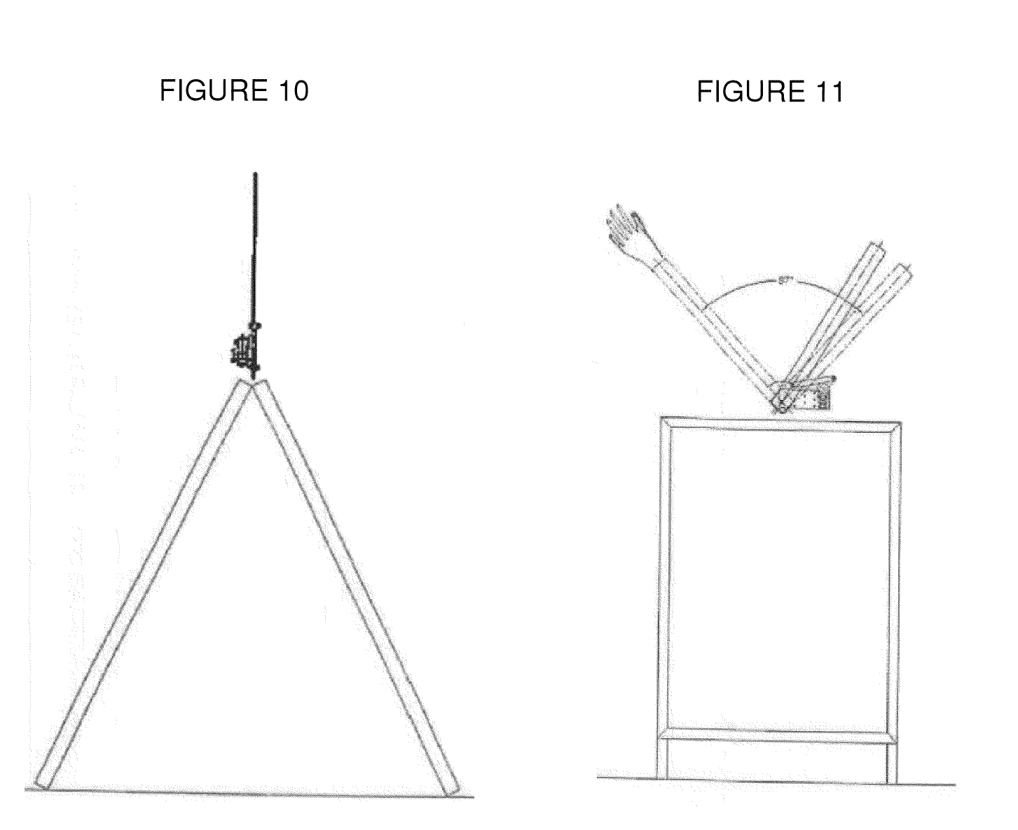

FIGS. 10 and 11 show a side view and a front view of the disclosure attached to a sandwich board or “A” frame sign, with the waving arm appearing to float above the sign. The figures show the entire bracket 200 removed to illustrate the inside mechanism attached to the waving arm and hand. Bracket 200 can be attached to the top or one side of this sandwich board using the various designs of bracket 200 discussed previously. Also, FIG. 11 shows a hand attached to the end of the waving arm with motion.

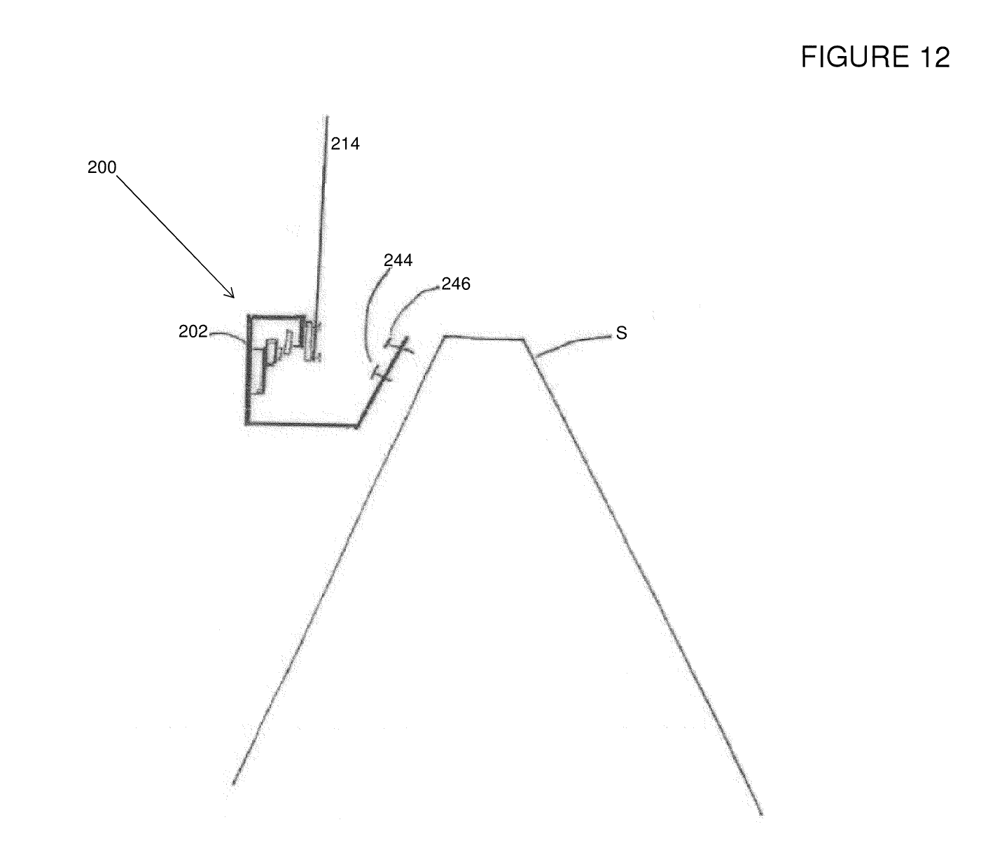

FIG. 12 shows a side view of bracket 200 being attached to the side of a sandwich board (S) with holes to accept fasteners 244, 246.

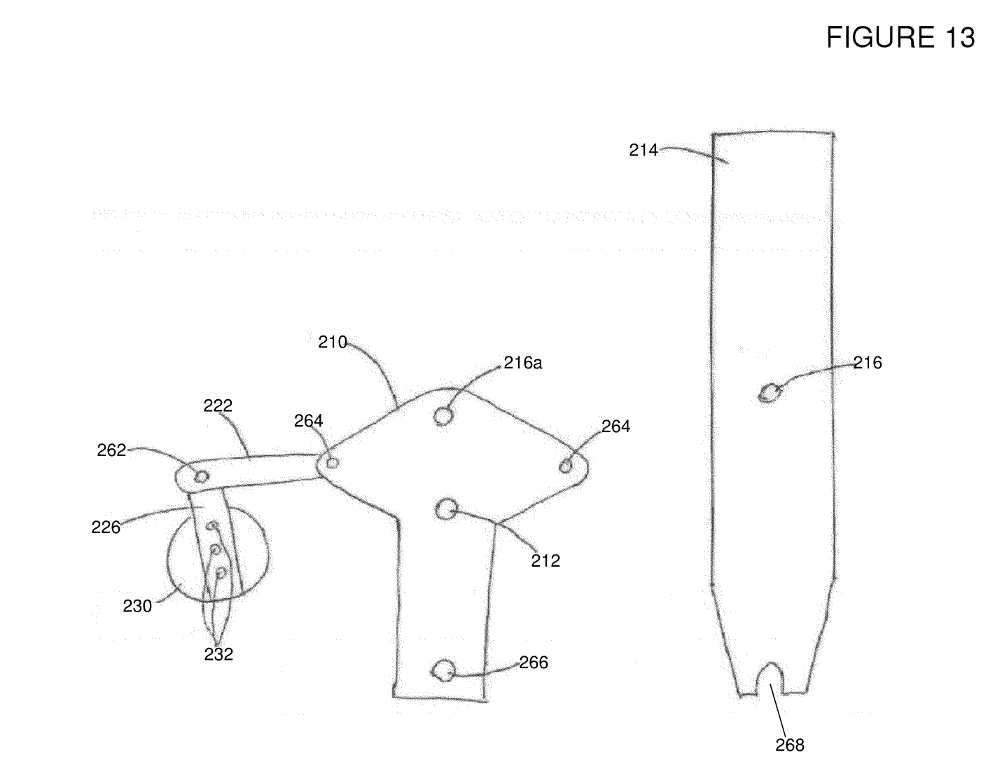

FIG. 13 shows the rocker plate 210 with the linkage rod 222 and crank arm 226. A pin 262 connects the crank arm 226 and linkage rod 22 together but allows them to pivot relative to one another. Similarly, a pin 264 connects the linkage rod 222 to the rocker plate 210. The gear head wheel 230 is attached to the crank arm 226 with three screws 232 to secure these components so that the crank arm 226 cannot rotate around gear head wheel 230 but rotates with the gear head wheel, thereby driving linkage rod 222. Rocker plate 210 is mounted for rotation on the fixed pivot pin 212 so that the rocker plate rocks back and forth around this axis point. Post 266 on rocker plate 210 accepts the notch 268 at the bottom of waving arm 214. Arm 214 is attached with a removable fastener at 216. Arm 214 will cover over pivot pin 212 and is not attached at this axis point 212. Instead, waving arm 214 is only secured by post 266 and removable fastener 216. Linkage rod 222 can be attached to either wing of the rocker plate 210 by holes on either side of the lateral wings, as seen in FIG. 13.

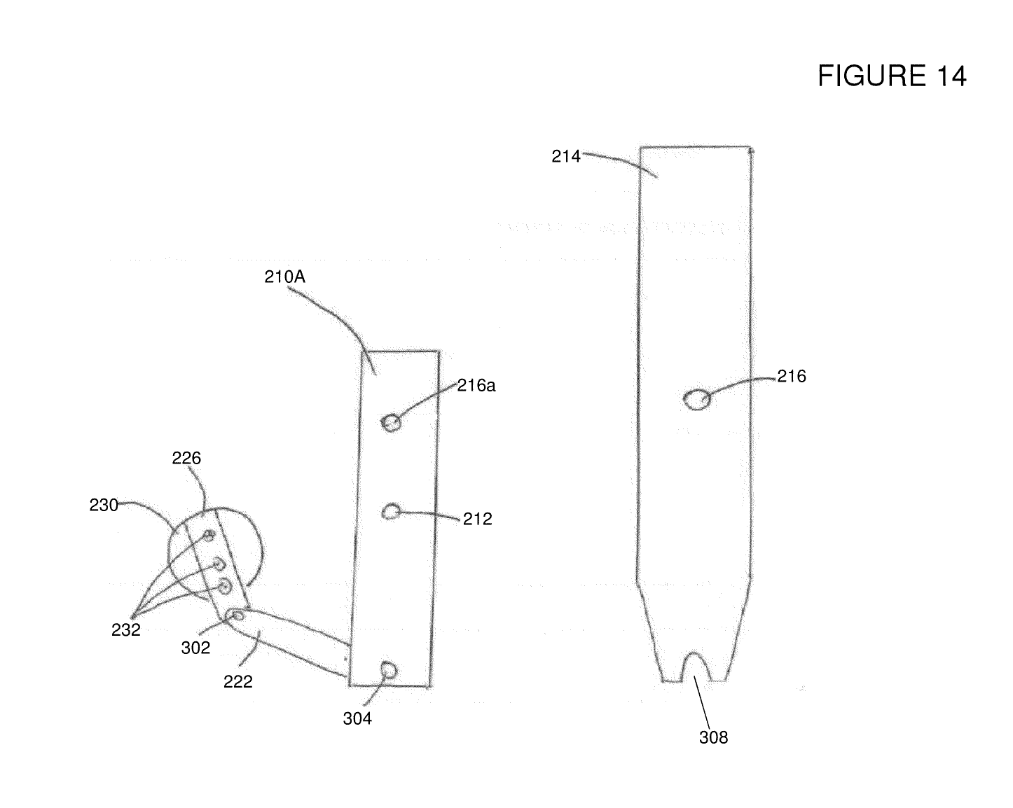

FIG. 14 shows a similar assembly as in FIG. 13. However the rocker plate 210A has no wings sticking out on its sides and is just a rectangular shape. Rocker plate 201A is attached to linkage rod 222 at its bottom by connecting at pin 264. This scheme eliminates the extra material on the sides of the rocker plate 201A and affords a more compact assembly. All of the other components shown in FIG. 14 correspond to those of FIG. 13.

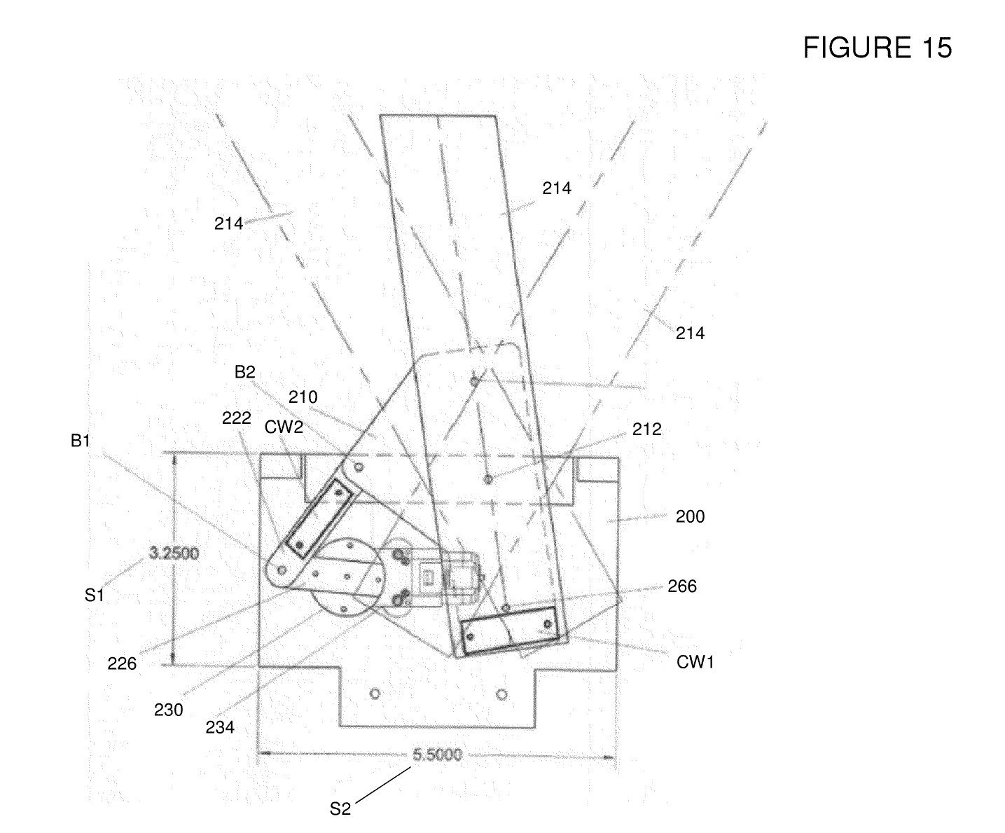

FIG. 15 shows a front view of an alternate embodiment of the device. It is the same front view as in FIG. 6 except a counterweight CW1 has been added to the bottom of rocker plate 210 and/or a counterweight CW2 can additionally be added on linkage rod 222. The counterweights can help with torque and balance of the moving components. S1 shows the height in inches (3.25″) and S2 shows the length in inches (5.5″) with an approximate depth of 3″-5″. These are approximate dimensions that are for example only and the invention is not limited thereto. These dimensions would be appropriate for a device that would attach to one of the front sides of a sandwich board or other types of signage and can vary depending on the size motor, linkages, rocker plate and counterweights being used. A typical sandwich board is 2 feet wide by 3 feet high on each of its sides and is hinged at the top with a wider open base. The waving arm 214 in FIG. 15 is shown moving in an arc in three positions. Pivot pin 212 shows the fixed axis point of rocker plate 210. Post 264 on rocker plate 210 accepts the notch 268 at the bottom of waving arm 214. Waving arm 214 is fastened at 216 on rocker plate 210. The crank arm is seen at 226 while the gear head 230 is oriented at 90 degrees from the motor 234. Bushings B1, B2 can replace pins 262, 264 and at the pivot pin 212. The bushings at B1, B2 and 212 would allow for tighter connections to the crank arm 226 attached to linkage rod 222 and attached to rocker plate 210, allowing these moving parts to have less friction.

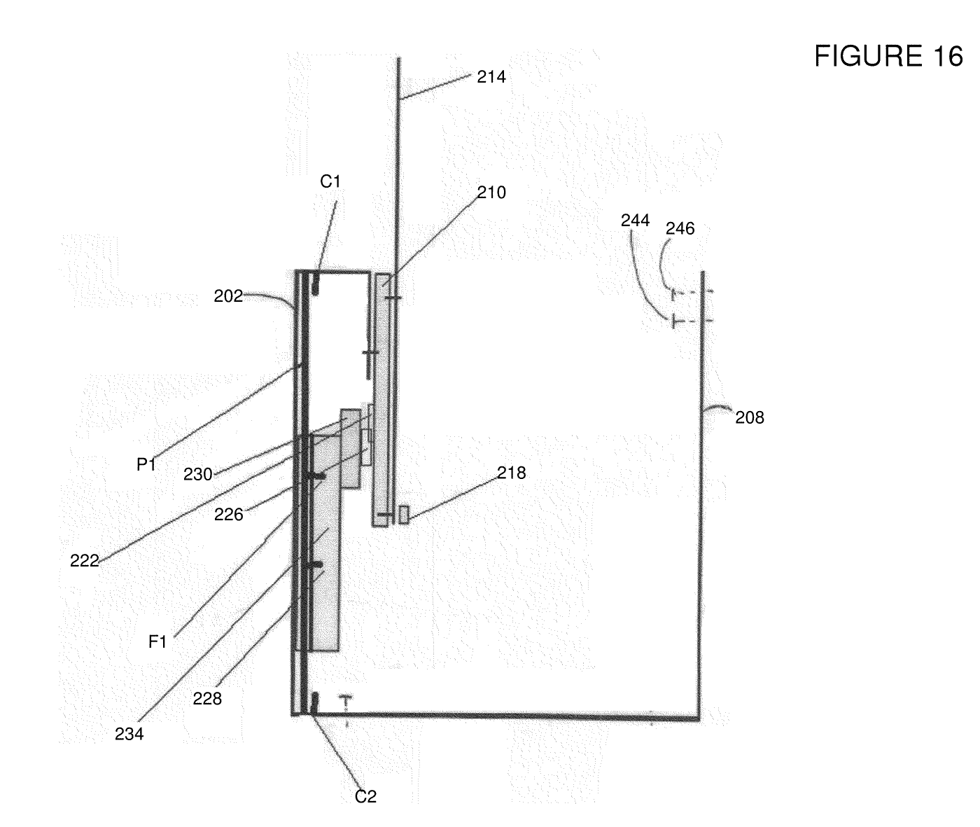

FIG. 16 shows a side view of the device similar to that of FIG. 8. However, in this embodiment a slide out card is located at P1 to which the motor 234 is attached. The motor is attached to P1 by fasteners F1 and F2. All the other components are attached accordingly as in FIG. 15. Stops C1 and C2 hold the card in place to keep the motor and running components from moving forward or back. The stops C1 and C2 can be fastened to bracket 200 on both the lower and upper corners of the bracket. If side panels (not shown) are fastened to the bracket 200, one of the sides would need to be removed to access the slide out card PI so as to remove the slide out card from bracket 200. Stops C1 and C2 would allow the card PI to slide out one of the sides on bracket 200 but not allow card PI to move forward or back while resting inside of bracket 200, only from side to side. This slide out card feature is so that if the motor ever needed to be replaced it could be accessed more easily by opening up one of the side panels on bracket 200 and pulling out the slide out card PI. Before the slide out card PI can be pulled out from bracket 200 one of the fasteners or bushing on the crank arm or linkage arm would have to be removed to release the motor gearbox housing from the linkage or crank arm assembly.

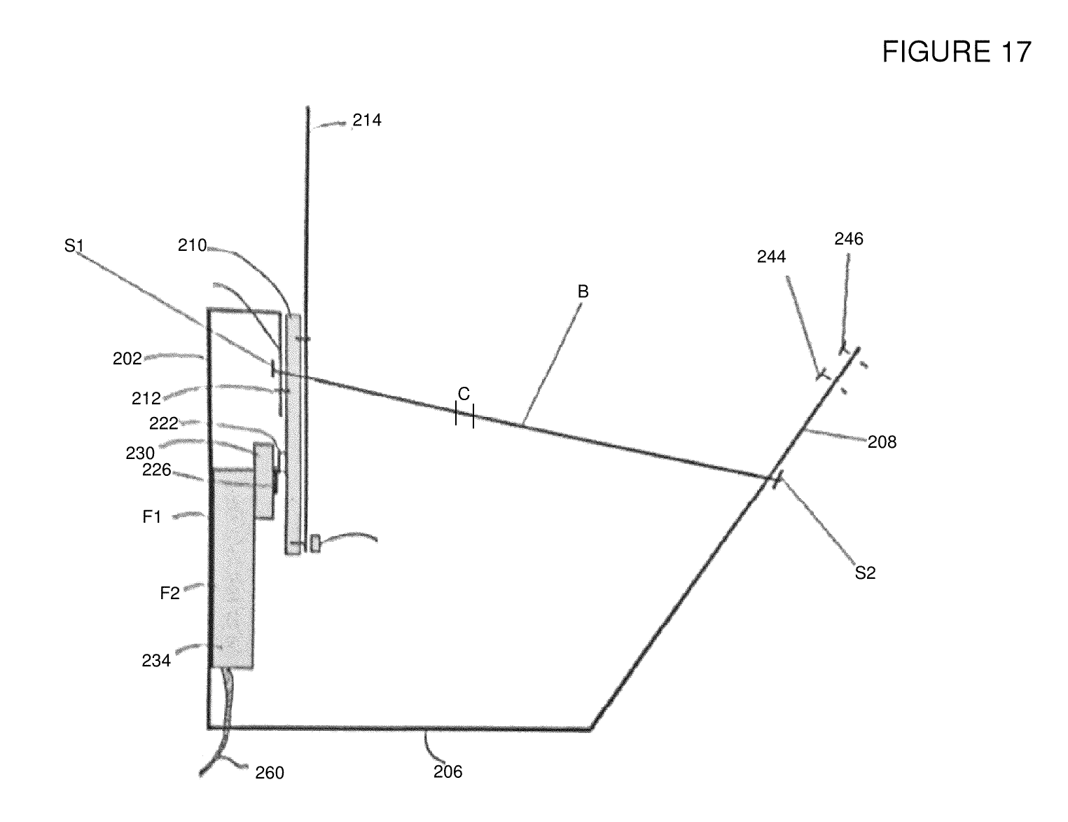

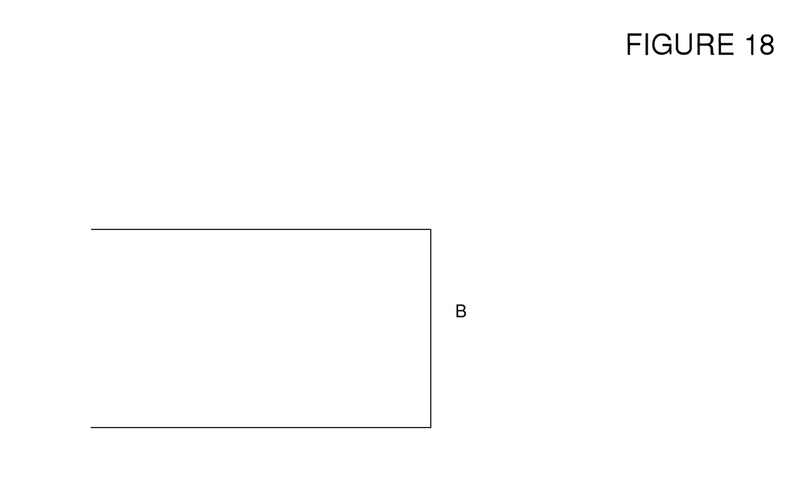

FIG. 17 shows a side elevation view similar to FIG. 7, however a brace B made out of any material including elastic and is designed to add stability to mounting flap 208 by holding it tight to front flap 204 of bracket 200. The brace B would be attached to each side of front flap 204 so as to not interfere with the waving arm 214. Stops S1 in FIG. 17 would keep the brace B attached to front flap 204 and not allow it to pull through. Holes in front flap 204 allow for attachment of brace B at stops S1. The brace B can extend to the back of mounting flap 208 and go all the way behind it and then attach to the other end of mounting flap 208 and then connect to the other side of front flap 204, as a “U” shape where the bottom of the “u” is held behind mounting flap 208. See FIG. 18. Additionally, brace B can have connectors C on both sides so as to be removably fastened and adjusted for different angles of mounting flap 208. Brace B can be of any width on its three sides and will act to stabilize and support mounting flap 208.

This disclosure can use a single bracket plate to hold all of the components and attach itself to an advertising sign horizontally, vertically or sloped. It can be attached to the side or on the top of any sandwich board or “A” frame sign. This disclosure can use a bracket with one side and one bottom to attach to different materials such as plastic wood or other. This disclosure can use a bracket with two sides and one bottom to attach to different materials such as plastic wood or other. This disclosure can use a bracket with two sides and one bottom to attach to different materials such as plastic wood or other. This disclosure can use a bracket with two or more sides and one bottom and top (such as a box shape which would have a slot at the top for the waving arm to move back and forth) to attach to different materials such as plastic wood or other.

This disclosure can have many designs scenarios to configure the motor, crank arm, linkages and waving arm. Any configuration or combination of such components will work and are encompassed by this disclosure but it is important that whatever configuration of the motor and connecting parts assembled that create the arm to swing or rock back and forth, the force should be adequate to create enough torque to rock or swing the arm back and forth in windy, rainy, or inclement weather conditions so that the mechanism will continue to work.

The waving arm can have any arc to it but an ideal arc would be between 85 degrees and 50 degrees so as to have enough swinging motion to attract attention to itself.

This disclosure will use any combination of motor and mechanical geometry of parts to convert rotating motion to rocking or swinging back and forth motion.

This disclosure will use any combination of motor and mechanical geometry of parts to convert rotating motion to rocking or swinging back and forth motion assembled on a single bracket or plate that attaches itself to the side of any advertising signage or structure either horizontally, vertically or sloped.

Adjustable sides can be removeably fastened to the main bracket holding all of the components. The adjustable bracket will keep the base from bouncing or moving around when in operation.

This disclosure will use any combination of motor and mechanical geometry of parts to convert rotating motion to rocking or swinging back and forth motion assembled on a single bracket, plate or bracket with multiple sides that attaches itself to the side of any advertising signage or structure either horizontally, vertically or sloped.

This disclosure will use any combination of motor and mechanical geometry of parts to swing or rock back and forth an extending arm to the side, top or any direction of the assembled parts that are attached to a single bracket, plate or bracket with multiple sides that attaches itself to the side of any advertising signage or structure either horizontally, vertically or sloped.

This disclosure will use any combination of motor and mechanical geometry of parts assembled onto a single bracket or bracket, with multiple sides and made of any material that swings or rocks back and forth an extending arm to the side, top or any direction of the assembled components and that attaches itself to the side of any advertising signage or other structure either horizontally, vertically or sloped.

This disclosure will use any combination of motor and mechanical geometry of parts to swing or rock back and forth an extending arm with enough torque to swing the arm in inclement weather conditions to the side, top or any direction of the assembled parts on the supporting sign that are attached to a single bracket, plate or bracket with multiple sides (including a box shape) that attaches itself to the side of any advertising signage or other structure either horizontally, vertically or sloped.

In one embodiment the motor can be coupled to the gearbox in parallel or at a right angle. Both the motor and gearbox are sealed and not exposed to more inclement weather conditions. The motor we are using in this new design is a high efficiency 3V DC motor coupled to a 228:1 gearbox which provides a low power gear motor. This gear motor is designed for low-voltage power-efficiency, it's a slow, power-efficient motor weighing 35.7g(1.26 oz), measuring 51.7 mm (2.04)″ long, 27.3 mm (1.07″) wide, and 32.1 mm (1.26″) deep, excluding the shaft. The gear motor is also fitted with a slip clutch in case the mechanism gets jammed.

The power supply is now housed inside the cover which is attached to the main chassis with screws and may consist of 4 “C-cell batteries”, however various size batteries and multiples can be used. The robotic waver has been designed to run on batteries if no other energy source is available e.g. solar power or AC/DC converter. My design uses C-cell batteries as the best common battery for this purpose. The C-cell is small enough to be compact and yet large enough to give many more hours of operation than the very compact AA-cell.

A material and/or fabric preferable strong, lightweight, water resistant and/or water proof can be used to wrap around the reciprocating or rocking arm. The material will have fasteners such as a hook and loop, button or other to adjoin the two sides of the fabric. At the top of the fabric on one end a shaped material can be sewn on or attached to the fabric. The shaped material can be, for example, a hand or other eye-catching geometry, Additionally the material can made such as a sock that can then be pulled down the rotating or rocking arm and tied down at the bottom to secure it. The sleeve or sock shape can be made of fabric, foam, mold injected or other materials and have different colors and shapes such as hands or hands holding objects and are designed to slide over the arm and attached at the bottom of the arm with glue or simple fasteners. Additionally the waving arm and hand can be made of one continuous material such as Coroplast corrugated plastic or metal, wood or any other lightweight strong material. The arm and hand and/or many any other designs can be dye cut and stamped or mold injected out of many different materials.

It should be understood that various changes and modifications to the presently preferred embodiments described herein will be apparent to those skilled in the art. Such changes and modification can be made without departing from the spirit and scope of the invention disclosed herein.

1. A sign waver, comprising:
a chassis having a main plate;
a drive train including a motor and a gearbox coupled to the motor, the gearbox having an output shaft, one of the motor and gearbox being mounted on the main plate;
the drive train further including a rocker plate mounted on the main plate for repetitive motion, and a linkage connected to the output shaft and the rocker plate for imparting repetitive motion to the rocker plate; and
a waving arm connected to the rocker plate for repetitive motion therewith.

2. The sign waver of claim 1 wherein the waving arm is removably connected to the rocker plate.

3. The sign waver of claim 1 wherein the linkage comprises a crank arm mounted for rotation with the output shaft, a linkage rod pivotally connected to the crank arm and pivotally connected to the rocker plate.

4. The sign waver of claim 3 wherein the drive train further comprises a counterweight connected to the rocker plate.

5. The sign waver of claim 3 wherein the crank arm comprises a hub mounted on the output shaft and a plate connected to the hub, the plate having a lobe extending radially from the axis of the output shaft.

6. The sign waver of claim 5 wherein the linkage rod is connected at one end to the lobe of the crank plate.

7. The sign waver of claim 1 wherein drive train further comprises a counterweight connected to the rocker plate.

8. The sign waver of claim 7 wherein the main plate has at least one slot formed therein and the rocker plate is mounted to the main plate on one side thereof and the counterweight is mounted on the other side of the main plate, the counterweight and rocker plate being joined by at least one connector extending through said slot in the main plate.

9. The sign waver of claim 1 further comprising a cover attached to the chassis and enclosing at least the motor.

10. The sign waver of claim 9 wherein the chassis further comprises at least one flange extending from the main plate, with the cover removably fastened to the flange.

11. The sign waver of claim 1 wherein the linkage imparts a reciprocating motion to the rocker plate.

12. The sign waver of claim 1 further comprising a connector plate connectable to the chassis in at least two positions so as to extend from the chassis at two different angles thereto.

13. The sign waver of claim 1 wherein the chassis further comprises a foot attached to the main plate and extending out of the plane thereof, and a toe plate attached to the foot and extending out of the plane of the foot, the sign waver further comprising a connector plate having a body portion connectable to the toe plate and a flange connectable to the foot.

14. The sign waver of claim 13 wherein the flange of the connector plate extends perpendicularly to the body portion of the connector plate.

15. A sign waver, comprising:
a chassis and a drive train mounted on the chassis, the driving train including a motor and an output shaft;
the drive train further including a rocker plate mounted on the chassis for repetitive motion, and a linkage connected to the output shaft and the rocker plate for imparting repetitive motion to the rocker plate; and
a waving arm connected to the rocker plate for repetitive motion therewith.

16. The sign waver of claim 15 wherein the waving arm is removably connected to the rocker plate.

17. The sign waver of claim 15 wherein the linkage comprises a crank arm mounted for rotation with the output shaft, a linkage rod pivotally connected to the crank arm and pivotally connected to the rocker plate.

18. The sign waver of claim 17 wherein the drive train further comprises a counterweight connected to the rocker plate.

19. The sign waver of claim 17 wherein the crank arm comprises a hub mounted on the output shaft and a plate connected to the hub, the plate having a lobe extending radially from the axis of the output shaft.

20. The sign waver of claim 19 wherein the linkage rod is connected at one end to the lobe of the crank plate.

21. The sign waver of claim 15 wherein drive train further comprises a counterweight connected to the rocker plate.

22. The sign waver of claim 21 wherein the main plate has at least one slot formed therein and the rocker plate is mounted to the main plate on one side thereof and the counterweight is mounted on the other side of the main plate, the counterweight and rocker plate being joined by at least one connector extending through said slot in the main plate.

23. A sign waver, comprising:
a chassis and a drive train mounted on the chassis, the driving train including a motor, an output shaft, a rocker plate mounted on the chassis for repetitive motion, and a linkage connected to the output shaft and the rocker plate for imparting repetitive motion to the rocker plate;
a waving arm connected to the rocker plate for repetitive motion therewith; and
a connector plate connectable to the chassis in at least two positions so as to extend from the chassis at two different angles thereto.

24. The sign waver of claim 23 wherein the chassis further comprises a main plate, a foot attached to the main plate and extending out of the plane thereof, and a toe plate attached to the foot and extending out of the plane of the foot, the connector plate having a body portion connectable to the toe plate and a flange connectable to the foot.
